(19) United States
(12) Patent Application Publication
(10) Pub. No.: US 2024/0095862 A1
(43) Pub. Date: Mar. 21, 2024

(54) METHOD FOR DETERMINING DANGEROUSNESS OF PERSON, APPARATUS, SYSTEM AND STORAGE MEDIUM

(71) Applicant: BOE Technology Group Co., Ltd., Beijing (CN)

(72) Inventor: Xibo ZHOU, Beijing (CN)

(21) Appl. No.: 18/274,516

(22) PCT Filed: Feb. 3, 2021
(86) PCT No.: PCT/CN2021/075135

§ 371 Date: Jul. 27, 2023

(51) Int. Cl. G06Q 50/26

(52) U.S. Cl. CPC G06Q 50/265

(57) ABSTRACT

Disclosed are a method for determining the dangerousness of a person, an apparatus, a system and a storage medium. The method includes: generating a historical trajectory of a specific person according to historical data of the specific person acquired by a plurality of devices within a designated time period, where the historical data includes a person identifier of the specific person, an acquisition time and a device identifier; determining suspicious behaviors of the specific person appearing in the historical trajectory by means of analyzing behaviors of the specific person according to the historical trajectory of the specific person; determining a suspicious level of the specific person according to a frequency of at least one of the suspicious behaviors appearing in a corresponding historical trajectory; and determining that the specific person is dangerous in a case that the suspicious level exceeds a first set threshold.

### CROSS REFERENCE TO RELATED APPLICATIONS

The present disclosure is a National Stage of International Application No. PCT/CN2021/075135, filed Feb. 3, 2021, which is hereby incorporated by reference in its entirety.

### TECHNICAL FIELD

The disclosure herein relates to the field of security protection, in particular to a method, apparatus and system for determining dangerousness of a person, and a storage medium.

### BACKGROUND

With the continuous improvement of urban construction, the management of large-scale high-end industrial, office or residential parks has become a huge challenge.

The arrival of the Internet of Things era has gradually evolved traditional management methods into automated and intelligent management methods. In some embodiments, in the construction of smart parks, park security protection is an important component of park management, and is used to protect the safety of internal assets and users in the park. Usually, a security protection system of a smart park has included functions such as personnel registration, gate security inspection, video surveillance, intrusion alarm, etc., which to some extent prevents illegal personnel outside the park from entering the park and causing harm. However, these technologies can only perform handling when suspicious personnel attempts to enter the park, while some unscrupulous individuals may fabricate reasons for their visit and infiltrate the park, making it difficult for security protection personnel to make effective judgments about such personnel.

### SUMMARY

The present disclosure provides a method, apparatus and system for determining dangerousness of a person and a storage medium, which are used for solving the above technical problems existing in the prior art.

In a first aspect, to solve the above technical problems, embodiments of the present disclosure provides a method for determining dangerousness of a person, including:
generating a historical trajectory of a specific person according to historical data of the specific person historical data acquired by a plurality of devices within a designated time period, where the historical data includes a person identifier of the specific person, an acquisition time and a device identifier;
determining suspicious behaviors of the specific person appearing in the historical trajectory by means of analyzing behaviors of the specific person according to the historical trajectory of the specific person; and
determining a suspicious level of the specific person according to a frequency of at least one of the suspicious behaviors appearing in a corresponding historical trajectory; and
determining that the specific person is dangerous in a case that the suspicious level exceeds a first set threshold.

In some embodiments, the generating the historical trajectory of the specific person according to the historical data of the specific person acquired by the plurality of devices within the designated time period, includes:
obtaining historical data of the person identifier within the designated time period according to the person identifier;
forming a movement trajectory from the historical data contained in the designated time period according to device identifiers corresponding to a plurality of acquisition times in accordance with an order of the acquisition times of the historical data; and
dividing the trajectory into a plurality of historical trajectories in a case that a time difference corresponding to two adjacent pieces of historical data in the movement trajectory is greater than a second set threshold, where the two adjacent pieces of historical data are located at one end of each of two different historical trajectories respectively.

In some embodiments, determining the suspicious behaviors of the specific person according to the historical trajectory of the specific person, includes:
determining, in a first period, short-term suspicious behaviors of the specific person existing in the historical trajectory and a number of times of the short-term suspicious behaviors by means of counting a frequency and law of the specific person appearing at each device; and
determining, in a second period, periodic suspicious behaviors of the specific person existing in the historical trajectory and a number of times of the periodic suspicious behaviors by means of counting the short-term suspicious behaviors of the specific person appearing in the historical trajectory, where the first period being shorter than the second period.

In some embodiments, the short-term suspicious behaviors include:
a staying behavior, a hovering behavior, a passing behavior and a behavior of appearing in a specific time period.

In some embodiments, the determining the short-term suspicious behaviors of the specific person existing in the historical trajectory and the number of times of the short-term suspicious behaviors by means of counting the frequency and law of the specific person appearing at each device, includes:
counting a staying duration of the specific person appearing at a device corresponding to each device identifier, determining the short-term suspicious behavior corresponding to the staying duration exceeding a first threshold as the staying behavior, and accumulating an appearing number of times of the staying behavior by 1;
counting an order of the specific person continuously appearing among the plurality of devices and coverage rates of the devices in the order, determining the short-term suspicious behavior corresponding to the coverage rate less than a second threshold as the hovering behavior, and accumulating an appearing number of times of the hovering behavior by 1, where the coverage rate is a ratio of a total number of the devices existing in the order to a total number of times of sequentially passing the devices;
counting an order of the specific person appearing among the plurality of devices and an average movement speed of passing the plurality of devices, determining that the corresponding short-term suspicious behavior is a passing behavior in a case that the specific person sequentially appears among the plurality of devices without shuttling and the corresponding average movement speed is less than a third threshold, and accumulating an appearing number of times of the passing behavior by 1; and
counting the staying behavior, the hovering behavior and the passing behavior appearing in a specific time period, determining that the corresponding short-term suspicious behavior is the behavior of appearing in the specific time period if any one of the staying behavior, the hovering behavior and the passing behavior exists in the specific time period, and accumulating an appearing number of times of the behavior of appearing in the specific time period by 1.

In some embodiments, the determining the periodic suspicious behaviors of the specific person existing in the historical trajectory by means of counting the short-term suspicious behaviors of the specific person appearing in the historical trajectory, includes:
counting a first total number of times of the staying behavior or the hovering behavior appearing in each set time period within one second period, and determining that a behavior appearing regularly exists in the corresponding set time period in a case that the first total number of times exceeds a fourth threshold; and counting a second total number of times of the staying behavior or the hovering behavior of the specific person appearing at each device within the one second period, and determining that a behavior appearing at a fixed position exists at the corresponding device in a case that the second total number of times exceeds a fifth threshold.

In some embodiments, a determining method of the second threshold includes:
determining a coverage rate mean value and a coverage rate standard error of coverage rates corresponding to the hovering behaviors of all specific persons in a selected historical time period by means of analyzing distribution of the coverage rates corresponding to the hovering behaviors of the specific person in the selected historical time period; and determining a difference value of the coverage rate mean value and N times of the coverage rate standard error as the second threshold.

In some embodiments, the determining the suspicious level of the specific person according to the frequency of at least one of the suspicious behaviors appearing in the corresponding historical trajectory, includes:
determining an initial suspicious level value for a suspicious level of each suspicious behavior;
accumulating, every time one suspicious behavior appears, the corresponding suspicious level by a first set value in a case that the one suspicious behavior is the short-term suspicious behavior; and accumulating, every time one suspicious behavior appears, the corresponding suspicious level by a second set value in a case that the one suspicious behavior is a long-term suspicious behavior, where the second set value is greater than the first set value;
decreasing a value of the suspicious level corresponding to the one short-term suspicious behavior by a third set value, in a case that one short-term suspicious behavior does not appear again within a duration corresponding to one second period after the one short-term suspicious behavior of the specific person appears; and
determining a sum of the suspicious levels corresponding to all the suspicious behaviors currently contained by the specific person as a current value of the suspicious level of the specific person.

In some embodiments, before the historical trajectory of the specific person is generated, the method further includes:
obtaining an image of the specific person shot in real time;
obtaining a corresponding face image from the image;
extracting a face feature from the face image;
comparing an extracted face feature with face features of historical face images in a face database;
obtaining the person identifier of the specific person from the face database in a case that the extracted face feature is successfully compared with the face features of historical face images in the face database;
storing the face image into the face database and assigning a corresponding person identifier to the face image, in a case that the extracted face feature fails to match the face features of the historical face images in the face database; and
determining whether the person identifier of the specific person is a person identifier in a white list; and
determining the person identifier of the specific person as a person identifier of a suspicious person in a case that the person identifier of the specific person is not a person identifier in a white list.

In a second aspect, an embodiment of the present disclosure provides an apparatus for determining dangerousness of a person, including:
a generating unit, configured to generate a historical trajectory of a specific person according to historical data of the specific person acquired by a plurality of devices within a designated time period, where the historical data includes a person identifier of the specific person, an acquisition time and a device identifier;
a selecting unit, configured to determine suspicious behaviors of the specific person appearing in the historical trajectory by means of analyzing behaviors of the specific person according to the historical trajectory of the specific person; and
a determining unit, configured to determine a suspicious level of the specific person according to a frequency of at least one of the suspicious behaviors appearing in a corresponding historical trajectory; and determine that the specific person is dangerous in a case that the suspicious level exceeds a first set threshold.

In some embodiments, the generating unit is further configured to:
obtain historical data of the person identifier within the designated time period according to the person identifier;
form a movement trajectory from the historical data contained in the designated time period according to device identifiers corresponding to a plurality of acquisition times in accordance with an order of the acquisition times of the historical data; and
divide the movement trajectory into a plurality of historical trajectories in a case that a time difference corresponding to two adjacent pieces of historical data in the movement trajectory is greater than a second set threshold, where the two adjacent pieces of historical data are located at one end of each of two different historical trajectories.

In some embodiments, the behavior selecting unit is further configured to:
determine, in a first period, short-term suspicious behaviors of the specific person existing in the historical trajectory and a number of times of the short-term suspicious behaviors by means of counting a frequency and law of the specific person appearing at each device; and
determine, in a second period, periodic suspicious behaviors of the specific person existing in the historical trajectory and a number of times of the periodic suspicious behaviors by means of counting the short-term suspicious behaviors of the specific person appearing in the historical trajectory, where the first period is shorter than the second period.

In some embodiments, the short-term suspicious behaviors include:
a staying behavior, a hovering behavior, a passing behavior and a behavior of appearing in a specific time period.

In some embodiments, the behavior selecting unit is further configured to:
count a staying duration of the specific person appearing at a device corresponding to each device identifier, determine the short-term suspicious behavior corresponding to the staying duration exceeding a first threshold as the staying behavior, and accumulate an appearing number of times of the staying behavior by 1;
count an order of the specific person continuously appearing among the plurality of devices and coverage rates of the devices in the order, determine the short-term suspicious behavior corresponding to the coverage rate less than a second threshold as the hovering behavior, and accumulate an appearing number of times of the hovering behavior by 1, where the coverage rate is a ratio of a total number of the devices existing in the order to a total number of times of sequentially passing the devices;
count an order of the specific person appearing among the plurality of devices and an average movement speed of passing the plurality of devices, determine that the corresponding short-term suspicious behavior is the passing behavior in a case that the specific person sequentially appears among the plurality of devices without shuttling and the corresponding average movement speed is less than a third threshold, and accumulate an appearing number of times of the passing behavior by 1; and
count the staying behavior, the hovering behavior and the passing behavior appearing in a specific time period, determine that the corresponding short-term suspicious behavior is the behavior of appearing in the specific time period if any one of the staying behavior, the hovering behavior and the passing behavior exists in the specific time period, and accumulate an appearing number of times of the behavior of appearing in the specific time period by 1.

In some embodiments, the behavior selecting unit is further configured to:
count a first total number of times of the staying behavior or the hovering behavior appearing in each set time period within one second period, and determine that a behavior appearing regularly exists in the corresponding set time period in a case that the first total number of times exceeds a fourth threshold; and count a second total number of times of the staying behavior or the hovering behavior of the specific person appearing at each device within the one second period, and determine that a behavior appearing at a fixed position exists at the corresponding device in a case that the second total number of times exceeds a fifth threshold.

In some embodiments, the behavior selecting unit is further configured to:
determine a coverage rate mean value and a coverage rate standard error of coverage rates corresponding to the hovering behaviors of all specific persons in a selected historical time period by means of analyzing distribution of the coverage rates corresponding to the hovering behaviors of the specific person in the selected historical time period; and
determine a difference value of the coverage rate mean value and N times of the coverage rate standard error as the second threshold.

In some embodiments, the determining unit is further configured to:
determine an initial suspicious level value for a suspicious level of each suspicious behavior;
accumulate, every time one suspicious behavior appears, the corresponding suspicious level by a first set value in a case that the one suspicious behavior is the short-term suspicious behavior; and accumulate, every time one suspicious behavior appears, the corresponding suspicious level by a second set value in a case that the one suspicious behavior is a long-term suspicious behavior, where the second set value is greater than the first set value;
decrease a value of the suspicious level corresponding to the one short-term suspicious behavior by a third set value, in a case that one short-term suspicious behavior does not appear again within a duration corresponding to one second period after the one short-term suspicious behavior of the specific person appears; and
determine a sum of the suspicious levels corresponding to all the suspicious behaviors currently contained by the specific person as a current value of the suspicious level of the specific person.

In some embodiments, the apparatus further includes a recognizing unit, and the recognizing unit is configured to:
obtain an image of the specific person shot in real time;
obtain a corresponding face image from the image;
extract a face feature from the face image;
compare an extracted face feature with face features of historical face images in a face database;
obtain the person identifier of the specific person from the face database in a case that the extracted face feature is successfully compared with the face features of historical face images in the face database;
store the face image into the face database and assigning a corresponding person identifier to the face image, in a case that the extracted face feature fails to match the face features of the historical face images in the face database;
determine whether the person identifier of the specific person is a person identifier in a white list; and
determine the person identifier of the specific person as a person identifier of a suspicious person in a case that the person identifier of the specific person is not a person identifier in a white list.

In a third aspect, an embodiment of the present disclosure further provides a system for determining dangerousness of a person, including the apparatus in the second aspect and an image acquisition device.

In a fourth aspect, an embodiment of the present disclosure further provides an apparatus for determining dangerousness of a person, including:
at least one processor, and
a memory connected with the at least one processor; where
the memory stores instructions capable of being executed by the at least one processor, and the at least one processor, by executing the instructions stored in the memory, executes the method in the first aspect above.

In a fifth aspect, an embodiment of the present disclosure further provides a readable storage medium, including:
a memory, where
the memory is configured to store instructions, and the instructions, when executed by a processor, cause an apparatus including the readable storage medium to complete the method in the first aspect above.

### BRIEF DESCRIPTION OF FIGURES

FIG. 1 is flow diagram of a method for determining dangerousness of a person provided by an embodiment of the present disclosure.

FIG. 2 is a schematic structural diagram of an apparatus for determining dangerousness of a person provided by an embodiment of the present disclosure.

### DETAILED DESCRIPTION

Embodiments of the present disclosure provide a method, apparatus and system for determining dangerousness of a person and a storage medium, which are used for solving the above technical problems existing in the prior art.

In order to better understand the above technical solutions, the technical solutions of the present disclosure are described in detail below through the accompanying drawings and embodiments. It should be understood that embodiments of the present disclosure and features in the embodiments are a detailed description of the technical solutions of the present disclosure, rather than a limitation of the technical solutions of the present disclosure. Without conflict, embodiments of the present disclosure and the technical features in the embodiments may be combined with each other.

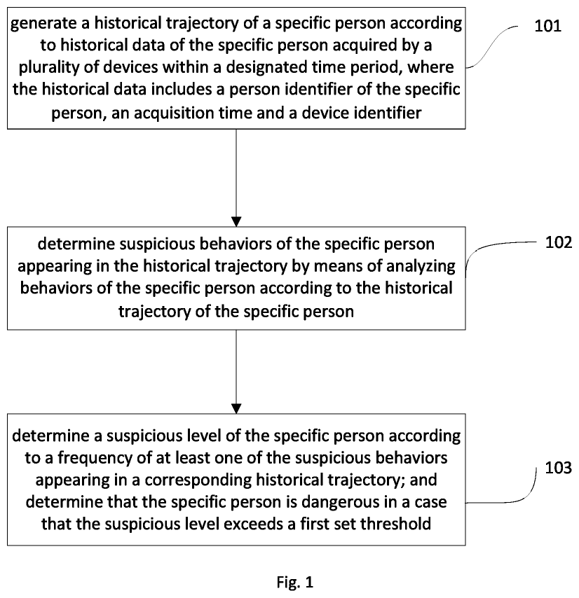

Referring to FIG. 1, an embodiment of the present disclosure provides a method for determining dangerousness of a person, and a handling process of the method is as follows.

Step 101: a historical trajectory of a specific person is generated according to the historical data of the specific person acquired by a plurality of devices within a designated time period, where the historical data includes a person identifier of the specific person, an acquisition time and a device identifier.

Prior to generating the historical trajectory of the specific person, an identity of the specific person further needs to be recognized if the plurality of devices above are image acquisition devices, which may be implemented in the following way:
obtaining an image of the specific person shot in real time; obtaining a corresponding face image from the image, extracting a face feature from the face image; comparing an extracted face feature with face features of historical face images in a face database; obtaining the person identifier of the specific person from the face database in a case that the extracted face feature is successfully compared with the face features of historical face images in the face database; storing the face image into the face database and assigning a corresponding person identifier to the face image, in a case that the extracted face feature fails to match the face features of the historical face images in the face database; determining whether the person identifier of the specific person is a person identifier in a white list; and determining the person identifier of the specific person as a person identifier of a suspicious person in a case that the person identifier of the specific person is not a person identifier in a white list.

In some embodiments, a plurality of image acquisition devices are deployed on the periphery of a smart park, and they cover key regions around the whole smart park and all entrances and exits of the smart park. Each image acquisition device performs real-time shooting on a region it monitors and transmits a shot image or video to a background (containing an acquisition time of the image, and a device identifier of the image acquisition device which acquires the image), the background recognizes a shot image or video frame image containing a visitor through a face recognition algorithm, obtains a corresponding face image, extracts a face feature from the face image (e.g., the face image is converted into a 512-dimensional feature vector by using a SeetaFace face recognition algorithm, of course, other face recognition algorithms, such as a neural network algorithm, may also be used), and then compares the face feature with face features (also a 512-dimensional feature vector accordingly) of historical face images in a face database, and a person identifier of the visitor is obtained from the face database if comparison succeeds. In the face database, each historical face image corresponds to one person identifier.

The face image of the specific person is stored into the face database if comparison between the face image and the historical face images in the face database fails, and a corresponding person identifier is assigned to the face image.

Non-suspicious persons may be excluded through a pre-stored white list after the person identifier of the specific person is determined, persons not in the white list are suspicious persons, and thus the person identifier of the specific person may be determined. The white list may include registered users and staff in the smart park and foreign affair persons having fixed cooperations with the park, etc.

In some embodiments, if a black list is stored, whether the specific person is a person in the black list may also be determined according to the person identifier of the specific person, if yes, only short-term behavior analysis (a specific short-term behavior analysis method is introduced later) may be performed when behavior analysis is performed on the person, and thus the dangerousness of the specific person may be determined in time and alarming is performed in time. What is stored in the black list is ex-offenders, who may be obtained from a public security system, or may be dangerous persons determined in the past security protection process, or may be ex-offenders obtained from other parks and property administrators.

The acquisition time of acquiring the image corresponding to the specific person, and the device identifier of the image acquisition device acquiring the image corresponding to the specific person may further form corresponding historical data after the person identifier of the specific person is determined, and the historical data are stored, so that the corresponding historical trajectory can be generated subsequently according to the historical data of the specific person.

Generating the historical trajectory of the specific person according to the historical data of the specific person acquired by the plurality of devices within the designated time period may be implemented in the following way:
obtaining historical data of the person identifier within the designated time period according to the person identifier; forming a movement trajectory from the historical data contained in the designated time period according to device identifiers corresponding to a plurality of acquisition times in accordance with an order of the acquisition times of the historical data; and dividing the movement trajectory into a plurality of historical trajectories in a case that a time difference corresponding to two adjacent pieces of historical data in the movement trajectory is greater than a second set threshold, where the two adjacent pieces of historical data are located at one end of each of two different historical trajectories respectively. In this way, the accuracy of short-term behavior analysis may be improved.

In some embodiments, a person identifier of a specific person A is 001, the designated time period is 24 hours before current time, all historical data of the person identifier 001 within 24 hours before the current time are obtained from a database and recorded as historical data 1 to historical data 10, the historical data form a movement trajectory, and the whole trajectory is the historical trajectory of the specific person within the designated time period if, in this historical data, a time difference of all adjacent historical data is less than or equal to the second set threshold.

The above movement trajectory is divided from the historical data 5 and the historical data 6 to form two historical trajectories (historical data 1 to historical data 5, and historical data 6 to historical data 10) if only the time difference between the historical data 5 and the historical data 6 is greater than the second set threshold.

The above trajectory is divided from the historical data 3 and the historical data 4 as well as the historical data 8 and the historical data 9 to form three historical trajectories: historical data 1 to historical data 3, historical data 4 to historical data 8 and historical data 9 to historical data 10, if only the time differences between the historical data 3 and the historical data 4 and the time differences between the historical data 8 and the historical data 9 are greater than the second set threshold.

Step 102 may be executed after the historical trajectory of the specific person is generated.

Step 102: determining suspicious behaviors of the specific person appearing in the historical trajectory by means of analyzing behaviors of the specific person according to the historical trajectory of the specific person.

The behaviors of the specific person may be analyzed after the historical trajectory of the specific person is obtained, and short-term behaviors and long-term behaviors are determined, which may be implemented in the following way.

In some embodiments, the short-term suspicious behaviors may include: a staying behavior, a hovering behavior, a passing behavior and a behavior of appearing in a specific time period.

The short-term suspicious behaviors may be determined by the following way:
determining, in a first period, short-term suspicious behaviors of the specific person existing in the historical trajectory and a number of times of the short-term suspicious behaviors by means of counting a frequency and law of the specific person appearing at each device. The first period may be, for example, several hours, one day, and two days.

There are following determining methods according to different types of the short-term suspicious behaviors.

For the first short-term suspicious behavior: counting a staying duration of the specific person appearing at a device corresponding to each device identifier, determining the short-term suspicious behavior corresponding to the staying duration exceeding a first threshold as the staying behavior, and accumulating an appearing number of times of the staying behavior by 1.

In some embodiments, taking an example that the device is an image acquisition device A, the staying duration may be a duration in which the image acquisition device A continuously acquires the specific person, assuming that the first threshold is 5 minutes, when the staying duration of the specific person at the image acquisition device A is 6 minutes, it may be determined that the short-term suspicious behavior of the specific person at the image acquisition device A is the staying behavior, and the appearing number of times of the staying behavior is accumulated by 1 (assuming that the staying behavior of the specific person appears for the first time at present, a total number of times of appearing of the corresponding staying behavior is 1).

For the second short-term suspicious behavior: counting an order of the specific person continuously appearing among the plurality of devices and coverage rates of the devices in the order, determining the short-term suspicious behavior corresponding to the coverage rate less than a second threshold as the hovering behavior, and accumulating an appearing number of times of the hovering behavior by 1, the coverage rate being a ratio of a total number of the devices existing in the order to a total number of times of sequentially passing the devices.

In some embodiments, a trajectory point of the specific person in the historical trajectory thereof is recorded as <device identifier, acquisition time>, and the historical trajectory of the specific person is: <1, 14:00:00>, <1, 14:05:23>, <2, 14:05:25>, <2, 14:08:42>, <3, 14:08:45>, <3, 14:15:00>, <2, 14:15:10>, <2, 14:20:54>, <1, 14:25:42>, <1, 14:27:00>. According to the historical trajectory, it may be determined that the specific person repeatedly appears among the devices 1, 2 and 3 according to the order: 1→0.1→0.2→0.2→0.3→0.3→0.2→0.2→0.1→1, the total number of the devices existing in the order is 3, and the total number of times of sequentially passing the different devices is 5. A corresponding coverage rate is 3/5=0.6, assuming that the second threshold is 0.7, it may be determined that the short-term suspicious behavior of the specific person existing among the devices 1 to 3 is the hovering behavior, and the appearing number of times of the hovering behavior is accumulated by 1 (assuming that the hovering behavior of the specific person appears for the second time at present, a total number of times of appearing of the corresponding hovering behavior is 2).

For the third short-term suspicious behavior: counting an order of the specific person appearing among the plurality of devices and an average speed of passing the plurality of devices, determining that the corresponding short-term suspicious behavior is a passing behavior if the specific person sequentially appears among the plurality of devices without shuttling and the corresponding average speed is less than a third threshold, and accumulating an appearing number of times of the passing behavior by 1.

In some embodiments, the historical trajectory of the specific person is <1, 14:05:23>, <2, 14:08:42>, <3, 14:08:45>, <4, 14:15:10>, <5, 14:25:42>. According to the historical trajectory, it may be determined that the specific person appears in sequence among the devices 1-4 without shuttling, a time difference is calculated according to a distance between the device 1 and the device 5 and according to the acquisition time corresponding to the device 1 and the acquisition time corresponding to the device 5, and then the average speed is calculated. Assuming that the calculated average speed is less than the third threshold, it is determined that the short-term suspicious behavior of the specific person is the passing behavior, and the appearing number of times of the passing behavior is accumulated by 1 (assuming that the passing behavior of the specific person appears for the second time at present, a total number of times of appearing of the corresponding passing behavior is 2).

For the fourth short-term suspicious behavior: counting the staying behavior, the hovering behavior and the passing behavior appearing in a specific time period, determining that the corresponding short-term suspicious behavior is the behavior of appearing in the specific time period if any one of the staying behavior, the hovering behavior and the passing behavior exists in the specific time period, and accumulating an appearing number of times of the behavior of appearing in the specific time period by 1.

The specific time period may be a user-designated time period, such as 0:00 to 5:00 am., it is determined that the short-term suspicious behavior is the behavior of appearing in the specific time period if any one of the staying behavior, the hovering behavior and the passing behavior appears in the specific time period, and an appearing number of times of the behavior of appearing in the specific time period is accumulated by 1 (assuming that the behavior of appearing in the specific time period of the specific person appears for the sixth time at present, the total number of times of appearing of the corresponding behavior of appearing in the specific time period is 6).

Determining methods of the thresholds used in determining the above short-term suspicious behaviors may be implemented in the following way:
analyzing distribution of the staying duration corresponding to the staying behavior of all specific persons, distribution of the coverage rate corresponding to the hovering behavior and distribution of the average speed corresponding to the passing behavior in a selected historical time period, and determining a staying mean value and a staying standard error of the staying duration, a coverage rate mean value and a coverage rate standard error of the coverage rate and an average speed mean value and an average speed standard error of the average speed in the selected historical time period.

A sum of the staying mean value and N times of the staying standard error is determined as the first threshold, and N is a natural number less than a sixth threshold.

A difference value of the coverage rate mean value and N times of the coverage rate standard error is determined as the second threshold.

A difference value of the average speed mean value and N times of the average speed standard error is determined as the third threshold.

In some embodiments, N is 3, the first threshold is equal to a sum of staying mean value and 3 times staying standard error, the second threshold is equal to a difference of coverage rate mean value and 3 times coverage rate standard error, and the third threshold is equal to a difference of average speed mean value and 3 times average speed standard error.

An analysis period may further be extended after the short-term suspicious behaviors are determined, so that the long-term suspicious behaviors of the specific person are analyzed:
determining, in a second period (e.g., one week, one month), periodic suspicious behaviors of the specific person existing in the historical trajectory and a number of times of the periodic suspicious behaviors by means of counting the short-term suspicious behaviors of the specific person appearing in the historical trajectory.

It may be implemented in the following way.

Counting a first total number of times of the staying behavior or the hovering behavior appearing in each set time period within one second period, and determining that a behavior appearing regularly exists in the corresponding set time period when the first total number of times exceeds a fourth threshold.

In some embodiments, assuming that the second period is one week, set time periods are 3:00 to 6:00 and 22:00 to 24:00, first total numbers of times corresponding to the staying behavior and the hovering behavior appearing at 3:00 to 6:00 in one week are counted and are sequentially N1 and N2, first total numbers of times corresponding to the staying behavior and the hovering behavior appearing at 22:00 to 24:00 are counted and are sequentially N3 and N4, and if both N1 and N4 are greater than the fourth threshold and both N2 and N3 are less than the fourth threshold, it may be determined that the staying behavior appearing regularly exists at 3:00 to 6:00, and the hovering behavior appearing regularly exists at 22:00 to 24:00.

A second total number of times of the staying behavior or the hovering behavior of the specific person appearing at each device within the one second period is counted, and it is determined that a behavior appearing at a fixed position exists at the corresponding device when the second total number of times exceeds a fifth threshold.

In some embodiments, assuming that the second period is one week, a second total number of times of the staying behavior of the specific person appearing at the device A is counted to be M, M is greater than the fifth threshold, and then it is determined that the specific person has the behavior appearing at a fixed position at the device A.

The determining methods of the fourth threshold and the fifth threshold above may also adopt the similar methods for the second threshold and the third threshold.

Step 103 may be executed after the suspicious behaviors of the specific person are determined.

Step 103: a suspicious level of the specific person is determined according to a frequency of at least one of the suspicious behaviors appearing in the corresponding historical trajectory; and it is determined that the specific person is dangerous when the suspicious level exceeds a first set threshold.

Determining the suspicious level of the specific person according to the frequency of at least one of the suspicious behaviors appearing in the corresponding historical trajectory may be implemented in the following way:
determining an initial suspicious level value for a suspicious level of each suspicious behavior; accumulating, every time one suspicious behavior appears, the corresponding suspicious level by a first set value if the suspicious behavior is the short-term suspicious behavior; and accumulating the corresponding suspicious level by a second set value if the suspicious behavior is the long-term suspicious behavior, the second set value being greater than the first set value; decreasing, if the short-term suspicious behavior does not appear again within a duration corresponding to one second period after the short-term suspicious behavior of the specific person appears, a value of the suspicious level corresponding to the short-term suspicious behavior by a third set value; and determining a sum of the suspicious levels corresponding to all the types of suspicious behaviors currently contained by the specific person as a current value of the suspicious level of the specific person.

In some embodiments, a value of an initial suspicious level X of the staying behavior is 5, a value of an initial suspicious level Y of the hovering behavior is 10, when the hovering behavior of the specific person is found for the first time, an original value is added to the value of the suspicious level Y of the hovering behavior on the original basis, and Y is 20 at the moment, and when the staying behavior of the specific person is found for the first time, an original value is added to the value of the suspicious level X of the staying behavior on the original basis, and X is 10 at the moment. When the hovering behavior of the specific person is found for the second time, an original value is added to the value of the suspicious level Y of the hovering behavior on the original basis, and Y is 40 at the moment, and when the staying behavior of the specific person is found for the second time, an original value is added to the value of the suspicious level X of the staying behavior on the original basis, and X is 10 at the moment. However, the hovering behavior does not appear again within a duration (such as one week) corresponding to one second period after the hovering behavior of the specific person is found for the second time, and then the value of the suspicious level Y corresponding to the hovering behavior of the specific person is decreased by half on the original basis, and Y is 20 at the moment. Assuming that no other suspicious behavior of the specific person appears, the value of the current suspicious behavior of the specific person is a sum of the suspicious levels of the hovering behavior and the staying behavior (20+10=30).

In some embodiments, the specific person also has a behavior that the long-term suspicious behaviors appear regularly (the behavior appearing regularly includes the hovering behavior appearing regularly and the staying behavior appearing regularly), a sum (also may be a preset value) of the suspicious levels of the hovering behavior and the staying behavior included when such long-term suspicious behaviors (a behavior appearing regularly herein) appear for the first time is used as the initial suspicious level value of the suspicious behaviors, and when such long-term suspicious behaviors appear again, the corresponding suspicious level value may be accumulated by a corresponding original value. Assuming that the current suspicious behaviors of the specific person include the staying behavior, the hovering behavior and the behavior appearing regularly, their current corresponding values are the values of the suspicious levels in sequence and are 80, 50 and 130, and then the current value of the suspicious level of the specific person is a sum of the suspicious levels of the hovering behavior, the staying behavior and the behavior appearing regularly (50+80+130=260).

Determining methods of suspicious level values of other suspicious behaviors are similar thereto, the difference is that different suspicious behaviors correspond to different initial suspicious level values, and generally, the initial suspicious level value of the hovering behavior is greater than the initial suspicious level value of the staying behavior, and the initial suspicious level value of the staying behavior is greater than the initial suspicious level value of the passing behavior.

When the value of the suspicious level of the specific person exceeds the first set threshold, it may be determined that the specific person is dangerous, and at the moment, early-warning and prompting may be performed, or early-warning may be performed when the specific person is detected next time. For example, when it is determined for the first time that the specific person is dangerous, early-warning may be performed immediately, and relevant security protection staff is prompted (e.g., sending short messages, speech, etc.); or early-warning is directly performed when the specific person is recognized next time from an obtained video or picture, and the relevant security protection staff is prompted. The value of the suspicious level of the specific person may be further lowered or cleared to zero if it is determined that the specific person is not dangerous.

Whether the specific person has potential dangerousness may be determined by judging whether the suspicious level value corresponding to the specific person exceeds the first set threshold, and if the suspicious level value of any suspicious behavior is greater than the first set threshold, it is determined that the specific person has potential dangerousness, and early-warning is sent to make the security protection staff take corresponding measures. After early-warning, the security protection staff needs to judge the specific person, and the suspicious level value corresponding to the specific person is lowered or cleared to zero if misjudgment is confirmed; and the suspicious level value of the specific person is reserved if it is confirmed that the person needs to be expelled, and early-warning is performed again after the specific person is found again.

The determining method of the first set threshold above may also adopt the similar determining methods for the second threshold and the third threshold.

In the embodiment provided by the present disclosure, the corresponding historical trajectory is generated according to the historical data of the specific person contained in the designated time period; the behaviors of the specific person in the historical trajectory are analyzed, the suspicious behaviors of the specific person appearing in the historical trajectory are selected, and then the suspicious level of the specific person is determined according to the frequency of each suspicious behavior appearing in the corresponding historical trajectory; and it is determined that the visit of the specific person is dangerous when the suspicious level exceeds the first set threshold, so that the security protection staff is helped to exclude possible dangerousness of the specific person in advance.

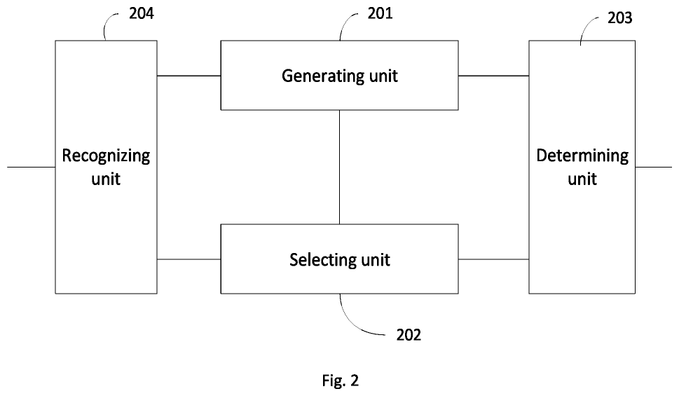

Based on the same inventive concept, an embodiment of the present disclosure provides an apparatus for determining dangerousness of a person. A specific implementation of a method for determining dangerousness of the person of the apparatus may refer to the description of the method embodiment, and repetitions are omitted. Referring to FIG. 2, the apparatus includes:
a generating unit 201, configured to generate a historical trajectory of a specific person according to the historical data of the specific person acquired by a plurality of devices within a designated time period, where the historical data includes a person identifier of the specific person, an acquisition time and a device identifier;
a selecting unit 202, configured to determine suspicious behaviors of the specific person appearing in the historical trajectory by means of analyzing behaviors of the specific person according to the historical trajectory of the specific person; and
a determining unit 203, configured to determine a suspicious level of the specific person according to a frequency of at least one of the suspicious behaviors appearing in a corresponding historical trajectory; and determine that visit of the specific person is dangerous when the suspicious level exceeds a first set threshold.

In some embodiments, the generating unit 201 is further configured to:
obtain historical data of the person identifier within the designated time period according to the person identifier;
form a movement trajectory from the historical data contained in the designated time period according to device identifiers corresponding to a plurality of acquisition times in accordance with an order of the acquisition times of the historical data; and
divide the movement trajectory into a plurality of historical trajectories in a case that a time difference corresponding to two adjacent pieces of historical data in the movement trajectory is greater than a second set threshold, where the two adjacent pieces of historical data are located at one end of each of two different historical trajectories respectively.

In some embodiments, the behavior selecting unit 202 is further configured to:
determine, in a first period, short-term suspicious behaviors of the specific person existing in the historical trajectory and a number of times of the short-term suspicious behaviors by means of counting a frequency and law of the specific person appearing at each device; and
determine, in a second period, periodic suspicious behaviors of the specific person existing in the historical trajectory and a number of times of the periodic suspicious behaviors by means of counting the short-term suspicious behaviors of the specific person appearing in the historical trajectory.

In some embodiments, the short-term suspicious behaviors include:
a staying behavior, a hovering behavior, a passing behavior and a behavior of appearing in a specific time period.

In some embodiments, the behavior selecting unit 202 is further configured to:
count a staying duration of the specific person appearing at a device corresponding to each device identifier, determine the short-term suspicious behavior corresponding to the staying duration exceeding a first threshold as the staying behavior, and accumulate an appearing number of times of the staying behavior by 1;
count an order of the specific person continuously appearing among the plurality of devices and coverage rates of the devices in the order, determine the short-term suspicious behavior corresponding to the coverage rate less than a second threshold as the hovering behavior, and accumulate an appearing number of times of the hovering behavior by 1, the coverage rate being a ratio of a total number of the devices existing in the order to a total number of times of sequentially passing the devices;
count an order of the specific person appearing among the plurality of devices and an average movement speed of passing the plurality of devices, determine that the corresponding short-term suspicious behavior is a passing behavior if the specific person sequentially appears among the plurality of devices without shuttling and the corresponding average movement speed is less than a third threshold, and accumulate an appearing number of times of the passing behavior by 1; and
count the staying behavior, the hovering behavior and the passing behavior appearing in a specific time period, determine that the corresponding short-term suspicious behavior is the behavior of appearing in the specific time period if any one of the staying behavior, the hovering behavior and the passing behavior exists in the specific time period, and accumulate an appearing number of times of the behavior of appearing in the specific time period by 1.

In some embodiments, the behavior selecting unit 202 is further configured to:
count a first total number of times of the staying behavior or the hovering behavior appearing in each set time period within one second period, and determine that a behavior appearing regularly exists in the corresponding set time period when the first total number of times exceeds a fourth threshold; and
count a second total number of times of the staying behavior or the hovering behavior of the specific person appearing at each device within the one second period, and determine that a behavior appearing at a fixed position exists at the corresponding device when the second total number of times exceeds a fifth threshold.

In some embodiments, the behavior selecting unit 202 is further configured to:
determine a coverage rate mean value and a coverage rate standard error of coverage rates corresponding to the hovering behaviors of all specific persons in a selected historical time period by means of analyzing distribution of the coverage rates corresponding to the hovering behaviors of the specific person in a selected historical time period; and
determine a difference value of the coverage rate mean value and N times of the coverage rate standard error as the second threshold.

In some embodiments, the determining unit 203 is further configured to:
determine an initial suspicious level value for a suspicious level of each suspicious behavior;
accumulate, every time one suspicious behavior appears, the corresponding suspicious level by a first set value in a case that the one suspicious behavior is the short-term suspicious behavior, and accumulate, every time one suspicious behavior appears, the corresponding suspicious level by a second set value in a case that the one suspicious behavior is a long-term suspicious behavior, the second set value being greater than the first set value;
decrease a value of the suspicious level corresponding to the one short-term suspicious behavior by a third set value, in a case that one short-term suspicious behavior does not appear again within a duration corresponding to one second period after the one short-term suspicious behavior of the specific person appears; and
determine a sum of the suspicious levels corresponding to all the suspicious behaviors currently contained by the specific person as a current value of the suspicious level of the specific person.

In some embodiments, the apparatus further includes a recognizing unit 204, and the recognizing unit 204 is configured to:
obtain an image of the specific person shot in real time;
obtain a corresponding face image from the image;
extract a face feature from the face image;
comparing an extracted face feature with face features of historical face images in a face database;
obtain the person identifier of the specific person from the face database in a case that the extracted face feature is successfully compared with the face features of historical face images in the face database;
store the face image into the face database and assign a corresponding person identifier to the face image, in a case that the extracted face feature fails to match the face features of the historical face images in the face database; and
determine whether the person identifier of the specific person is a person identifier in a white list; and
determine the person identifier of the specific person as a person identifier of a suspicious person in a case that the person identifier of the specific person is not a person identifier in a white list.

Based on the same inventive concept, an embodiment of the present disclosure provides a system for determining dangerousness of a person, including the apparatus for determining dangerousness of the person as described above and an image acquisition device.

Based on the same inventive concept, an embodiment of the present disclosure provides an apparatus for determining dangerousness of a person, including at least one processor, and
a memory connected with the at least one processor; where
the memory stores instructions capable of being executed by the at least one processor, and the at least one processor, by executing the instructions stored in the memory, executes the method for determining dangerousness of the person as described above.

Based on the same inventive concept, an embodiment of the present disclosure further provides a readable storage medium, including:
a memory, where
the memory is configured to store instructions, and the instructions, when executed by a processor, cause an apparatus including the readable storage medium to complete the method for determining dangerousness of the person as described above.

Those skilled in the art will appreciate that the embodiments of the present disclosure may be provided as methods, systems, or computer program products. Therefore, the embodiments the present disclosure may take the form of a full hardware embodiment, a full software embodiment, or an embodiment combining software and hardware. Besides, the embodiments of the present disclosure may adopt the form of a computer program product implemented on one or more computer available storage media (including, but not limited to, a disk memory, a CD-ROM, an optical memory and the like) containing computer available program codes.

The embodiments of the present disclosure are described with reference to the flow diagrams and/or block diagrams of the method, device (system), and computer program product according to the embodiments of the present disclosure. It should be understood that each flow and/or block in the flow diagram and/or block diagram and the combination of flows and/or blocks in the flow diagram and/or block diagram can be implemented by computer program instructions. These computer program instructions can be provided to processors of a general-purpose computer, a special-purpose computer, an embedded processor or other programmable data processing devices to generate a machine, so that instructions executed by processors of a computer or other programmable data processing devices generate an apparatus for implementing the functions specified in one or more flows of the flow diagram and/or one or more blocks of the block diagram.

These computer program instructions can also be stored in a computer-readable memory capable of guiding a computer or other programmable data processing devices to work in a specific manner, so that instructions stored in the computer-readable memory generate a manufacturing product including an instruction apparatus, and the instruction apparatus implements the functions specified in one or more flows of the flow diagram and/or one or more blocks of the block diagram.

These computer program instructions can also be loaded on a computer or other programmable data processing devices, so that a series of operation steps are executed on the computer or other programmable devices to produce computer-implemented processing, and thus, the instructions executed on the computer or other programmable devices provide steps for implementing the functions specified in one or more flows of the flow diagram and/or one or more blocks of the block diagram.

Apparently, those skilled in the art can make various modifications and variations to the present disclosure without departing from the spirit and scope of the present disclosure. In this way, if these modifications and variations of the present disclosure fall within the scope of the claims of the present disclosure and equivalent technologies thereof, the present disclosure is also intended to include these modifications and variations.

1. A method for determining dangerousness of a person, comprising:
generating a historical trajectory of a specific person according to historical data of the specific person acquired by a plurality of devices within a designated time period, wherein the historical data comprises a person identifier of the specific person, an acquisition time and a device identifier;
determining suspicious behaviors of the specific person appearing in the historical trajectory by means of analyzing behaviors of the specific person according to the historical trajectory of the specific person;
determining a suspicious level of the specific person according to a frequency of at least one of the suspicious behaviors appearing in a corresponding historical trajectory; and
determining that the specific person is dangerous in a case that the suspicious level exceeds a first set threshold.

2. The method according to claim 1, wherein the generating the historical trajectory of the specific person according to the historical data of the specific person acquired by the plurality of devices within the designated time period, comprises:
obtaining historical data of the person identifier within the designated time period according to the person identifier;
forming a movement trajectory from the historical data contained in the designated time period according to device identifiers corresponding to a plurality of acquisition times in accordance with an order of the acquisition times of the historical data; and
dividing the movement trajectory into a plurality of historical trajectories in a case that a time difference corresponding to two adjacent pieces of historical data in the movement trajectory is greater than a second set threshold, wherein the two adjacent pieces of historical data are located at one end of each of two different historical trajectories respectively.

3. The method according to claim 1, wherein determining the suspicious behaviors of the specific person according to the historical trajectory of the specific person, comprises:
determining, in a first period, short-term suspicious behaviors of the specific person existing in the historical trajectory and a number of times of the short-term suspicious behaviors by means of counting a frequency and law of the specific person appearing at each device; and
determining, in a second period, periodic suspicious behaviors of the specific person existing in the historical trajectory and a number of times of the periodic suspicious behaviors by means of counting the short-term suspicious behaviors of the specific person appearing in the historical trajectory, and determining, wherein the first period is shorter than the second period.

4. The method according to claim 3, wherein the short-term suspicious behaviors comprise:
a staying behavior, a hovering behavior, a passing behavior and a behavior of appearing in a specific time period.

5. The method according to claim 4, wherein the determining the short-term suspicious behaviors of the specific person existing in the historical trajectory and the number of times of the short-term suspicious behaviors by means of counting the frequency and law of the specific person appearing at each device, comprises:
counting a staying duration of the specific person appearing at a device corresponding to each device identifier, determining the short-term suspicious behavior corresponding to the staying duration exceeding a first threshold as the staying behavior, and accumulating an appearing number of times of the staying behavior by 1;
counting an order of the specific person continuously appearing among the plurality of devices and coverage rates of the devices in the order, determining the short-term suspicious behavior corresponding to the coverage rate less than a second threshold as the hovering behavior, and accumulating an appearing number of times of the hovering behavior by 1, wherein the coverage rate is a ratio of a total number of the devices existing in the order to a total number of times of sequentially passing the devices;
counting an order of the specific person appearing among the plurality of devices and an average movement speed of passing the plurality of devices, determining that the corresponding short-term suspicious behavior is a passing behavior in a case that the specific person sequentially appears among the plurality of devices without shuttling and the corresponding average movement speed is less than a third threshold, and accumulating an appearing number of times of the passing behavior by 1; and
counting the staying behavior, the hovering behavior and the passing behavior appearing in a specific time period, determining that the corresponding short-term suspicious behavior is the behavior of appearing in the specific time period if any one of the staying behavior, the hovering behavior and the passing behavior exists in the specific time period, and accumulating an appearing number of times of the behavior of appearing in the specific time period by 1.

6. The method according to claim 4, wherein the determining the periodic suspicious behaviors of the specific person existing in the historical trajectory by means of counting the short-term suspicious behaviors of the specific person appearing in the historical trajectory, comprises:
counting a first total number of times of the staying behavior or the hovering behavior appearing in each set time period within one second period, and determining that a behavior appearing regularly exists in the corresponding set time period in a case that the first total number of times exceeds a fourth threshold; and
counting a second total number of times of the staying behavior or the hovering behavior of the specific person appearing at each device within the one second period, and determining that a behavior appearing at a fixed position exists at the corresponding device in a case that the second total number of times exceeds a fifth threshold.

7. The method according to claim 5, wherein a determining method of the second threshold comprises:
determining a coverage rate mean value and a coverage rate standard error of coverage rates corresponding to the hovering behaviors of all specific persons in a selected historical time period by means of analyzing distribution of the coverage rates corresponding to the hovering behaviors of all specific persons in the selected historical time period; and
determining a difference value of the coverage rate mean value and N times of the coverage rate standard error as the second threshold.

8. The method according to claim 5, wherein the determining the suspicious level of the specific person according to the frequency of at least one of the suspicious behaviors appearing in the corresponding historical trajectory, comprises:
determining an initial suspicious level value for a suspicious level of each suspicious behavior;
accumulating, every time one suspicious behavior appears, the corresponding suspicious level by a first set value in a case that the one suspicious behavior is the short-term suspicious behavior;
and accumulating, every time one suspicious behavior appears, the corresponding suspicious level by a second set value in a case that the one suspicious behavior is a long-term suspicious behavior, wherein the second set value is greater than the first set value;
decreasing a value of the suspicious level corresponding to the one short-term suspicious behavior by a third set value, in a case that one short-term suspicious behavior does not appear again within a duration corresponding to one second period after the one short-term suspicious behavior of the specific person appears; and
determining a sum of the suspicious levels corresponding to all the suspicious behaviors currently contained by the specific person as a current value of the suspicious level of the specific person.

9. The method according to claim 1, wherein before the historical trajectory of the specific person is generated, the method further comprises:
obtaining an image of the specific person shot in real time;
obtaining a corresponding face image from the image;
extracting a face feature from the face image;
comparing an extracted face feature with face features of historical face images in a face database;
obtaining the person identifier of the specific person from the face database in a case that the extracted face feature is successfully compared with the face features of historical face images in the face database;
storing the face image into the face database and assigning a corresponding person identifier to the face image, in a case that the extracted face feature fails to match the face features of the historical face images in the face database;
determining whether the person identifier of the specific person is a person identifier in a white list; and
determining the person identifier of the specific person as a person identifier of a suspicious person in a case that the person identifier of the specific person is not a person identifier in a white list.

10. An apparatus for determining dangerousness of a person, comprising:
a generating unit, configured to generate a historical trajectory of a specific person according to historical data of the specific person acquired by a plurality of devices within a designated time period, wherein the historical data comprises a person identifier of the specific person, an acquisition time and a device identifier;
a selecting unit, configured to determine suspicious behaviors of the specific person appearing in the historical trajectory by means of analyzing behaviors of the specific person according to the historical trajectory of the specific person; and
a determining unit, configured to determine a suspicious level of the specific person according to a frequency of at least one of the suspicious behaviors appearing in a corresponding historical trajectory; and determine that the specific person is dangerous in a case that the suspicious level exceeds a first set threshold and perform early-warning.

11. A system for determining dangerousness of a person, comprising the apparatus for determining dangerousness of the person according to claim 10 and an image acquisition device.

12. An apparatus for determining dangerousness of a person, comprising:
at least one processor, and
a memory connected with the at least one processor; wherein
the memory stores instructions capable of being executed by the at least one processor, and the at least one processor, by executing the instructions stored in the memory, executes:
generating a historical trajectory of a specific person according to historical data of the specific person acquired by a plurality of devices within a designated time period, wherein the historical data comprises a person identifier of the specific person, an acquisition time and a device identifier;
determining suspicious behaviors of the specific person appearing in the historical trajectory by means of analyzing behaviors of the specific person according to the historical trajectory of the specific person; and
determining a suspicious level of the specific person according to a frequency of at least one of the suspicious behaviors appearing in a corresponding historical trajectory; and
determining that the specific person is dangerous in a case that the suspicious level exceeds a first set threshold.

13. A readable storage medium, comprising a memory, wherein the memory is configured to store instructions, and the instructions, when executed by a processor, cause an apparatus comprising the readable storage medium to complete the method according to claim 1.

14. The apparatus according to claim 12, wherein the at least one processor is configured to:
obtain historical data of the person identifier within the designated time period according to the person identifier;
form a movement trajectory from the historical data contained in the designated time period according to device identifiers corresponding to a plurality of acquisition times in accordance with an order of the acquisition times of the historical data; and
divide the movement trajectory into a plurality of historical trajectories in a case that a time difference corresponding to two adjacent pieces of historical data in the movement trajectory is greater than a second set threshold, wherein the two adjacent pieces of historical data are located at one end of each of two different historical trajectories respectively.

15. The apparatus according to claim 12, wherein the at least one processor is configured to:
determine, in a first period, short-term suspicious behaviors of the specific person existing in the historical trajectory and a number of times of the short-term suspicious behaviors by means of counting a frequency and law of the specific person appearing at each device; and
determine, in a second period, periodic suspicious behaviors of the specific person existing in the historical trajectory and a number of times of the periodic suspicious behaviors by means of counting the short-term suspicious behaviors of the specific person appearing in the historical trajectory, and determining, wherein the first period is shorter than the second period.

16. The apparatus according to claim 15, wherein the short-term suspicious behaviors comprise:
a staying behavior, a hovering behavior, a passing behavior and a behavior of appearing in a specific time period.

17. The apparatus according to claim 16, wherein the at least one processor is configured to:
count a staying duration of the specific person appearing at a device corresponding to each device identifier, determine the short-term suspicious behavior corresponding to the staying duration exceeding a first threshold as the staying behavior, and accumulate an appearing number of times of the staying behavior by 1;
count an order of the specific person continuously appearing among the plurality of devices and coverage rates of the devices in the order, determine the short-term suspicious behavior corresponding to the coverage rate less than a second threshold as the hovering behavior, and accumulate an appearing number of times of the hovering behavior by 1, wherein the coverage rate is a ratio of a total number of the devices existing in the order to a total number of times of sequentially passing the devices;
count an order of the specific person appearing among the plurality of devices and an average movement speed of passing the plurality of devices, determine that the corresponding short-term suspicious behavior is a passing behavior in a case that the specific person sequentially appears among the plurality of devices without shuttling and the corresponding average movement speed is less than a third threshold, and accumulate an appearing number of times of the passing behavior by 1; and
count the staying behavior, the hovering behavior and the passing behavior appearing in a specific time period, determine that the corresponding short-term suspicious behavior is the behavior of appearing in the specific time period if any one of the staying behavior, the hovering behavior and the passing behavior exists in the specific time period, and accumulate an appearing number of times of the behavior of appearing in the specific time period by 1.

18. The apparatus according to claim 16, wherein the at least one processor is configured to:
count a first total number of times of the staying behavior or the hovering behavior appearing in each set time period within one second period, and determine that a behavior appearing regularly exists in the corresponding set time period in a case that the first total number of times exceeds a fourth threshold; and
count a second total number of times of the staying behavior or the hovering behavior of the specific person appearing at each device within the one second period, and determine that a behavior appearing at a fixed position exists at the corresponding device in a case that the second total number of times exceeds a fifth threshold.

19. The apparatus according to claim 17, wherein the at least one processor is configured to:
determine a coverage rate mean value and a coverage rate standard error of coverage rates corresponding to the hovering behaviors of all specific persons in a selected historical time period by means of analyzing distribution of the coverage rates corresponding to the hovering behaviors of all specific persons in the selected historical time period; and
determine a difference value of the coverage rate mean value and N times of the coverage rate standard error as the second threshold.

20. The apparatus according to claim 17, wherein the at least one processor is configured to:
determine an initial suspicious level value for a suspicious level of each suspicious behavior;
accumulate, every time one suspicious behavior appears, the corresponding suspicious level by a first set value in a case that the one suspicious behavior is the short-term suspicious behavior;
and accumulate, every time one suspicious behavior appears, the corresponding suspicious level by a second set value in a case that the one suspicious behavior is a long-term suspicious behavior, wherein the second set value is greater than the first set value;
decrease a value of the suspicious level corresponding to the one short-term suspicious behavior by a third set value, in a case that one short-term suspicious behavior does not appear again within a duration corresponding to one second period after the one short-term suspicious behavior of the specific person appears; and
determine a sum of the suspicious levels corresponding to all the suspicious behaviors currently contained by the specific person as a current value of the suspicious level of the specific person.
